(19) United States
(12) Patent Application Publication
(10) Pub. No.: US 2008/0120514 A1
(43) Pub. Date: May 22, 2008

(54) THERMAL MANAGEMENT OF ON-CHIP CACHES THROUGH POWER DENSITY MINIMIZATION

(76) Inventors: Yehea Ismail, Morton Grove, IL (US); Gokhan Memik, Evanston, IL (US); Ja Chun Ku, Seoul (KR); Serkan Ozdemir, Evanston, IL (US)

Correspondence Address: MCANDREWS HELD & MALLOY, LTD, 500 WEST MADISON STREET, SUITE 3400, CHICAGO, IL, 60661, US

(21) Appl. No.: 11/938,040

(22) Filed: Nov. 9, 2007

Related U.S. Application Data
(60) Provisional application No. 60/865,272, filed on Nov. 10, 2006.

(51) Int. Cl. G06F 1/00

(52) U.S. Cl. 713/324; 711/118; 713/320

(57) ABSTRACT

Certain embodiments provide systems and methods for reducing power consumption in on-chip caches. Certain embodiments include Power Density-Minimized Architecture (PMA) and Block Permutation Scheme (BPS) for thermal management of on-chip caches. Instead of turning off entire banks, PMA architecture spreads out active parts in a cache bank by turning off alternating rows in a bank. This reduces the power density of the active parts in the cache, which then lowers the junction temperature. The drop in the temperature results in energy savings from the remaining active parts of the cache. BPS aims to maximize the physical distance between the logically consecutive blocks of the cache. Since there is spatial locality in caches, this distribution results in an increase in the distance between hot spots, thereby reducing the peak temperature. The drop in the peak temperature then results in a leakage power reduction in the cache.

### CROSS-REFERENCE TO RELATED APPLICATIONS

This application is related to, and claims the benefit of, Provisional Application No. 60/865,272, filed on Nov. 10, 2006, and entitled “Thermal Management of On-Chip Caches Through Power Density Minimization.” The foregoing application is herein incorporated by reference in its entirety.

### STATEMENT REGARDING FEDERALLY SPONSORED RESEARCH OR DEVELOPMENT

This invention was made with government support under Grant No. CCF-0541337 awarded by the National Science Foundation (NSF), Grant No. DE-FG02-05ER25691 awarded by the Department of Energy (DoE), and Northwestern Cufs Nos. 0830-350-J205 and 0680-350-FF02. The government has certain rights in the invention.

### BACKGROUND OF THE INVENTION

The present invention generally relates to thermal management of on-chip caches. More particularly, the present invention relates to thermal management of on-chip caches through power density reduction.

While there has been tremendous amount of work on low power cache design, researchers have not considered thermal effects into their optimization goals. Increasing power density and the associated thermal effects are arguably the most important problems for high-performance processors, such as the desktop and server processors produced by Intel, AMD, Sun, IBM, etc. As a result, most high-end microprocessor products are already employing thermal management techniques.

Various architectural power reduction techniques have been proposed for on-chip caches in the last decade. However, these techniques mostly ignore the effects of temperature on the power consumption.

The increasing significance of low-power VLSI (very large scale integration) designs has inspired a number of studies on power reduction techniques for on-chip caches. The main motivation behind these studies is the fact that a large fraction of the chip area is devoted to caches. For instance, 60% of a StrongARM processor is occupied by caches, and, in some cases, on-chip L1 caches alone can compromise over 40% of the total chip power budget. Initially, low-power cache designs have focused on reducing the dynamic power since it used to dominate the total power consumption. However, with the aggressive scaling of CMOS (complimentary metal oxide semiconductor) devices, the transistor threshold voltage and the supply voltage have scaled down simultaneously in order to maintain the performance improvement. This decrease in the threshold voltage has resulted in an exponential increase in the sub-threshold leakage current, which is the dominant source of leakage power. Leakage power has already become comparable to dynamic power, and it is projected to dominate the total chip power in nanometer scale technologies. Thus, the focus of low-power design has been shifting towards reducing the leakage power instead of the dynamic power, especially through suppressing the sub-threshold current. Since caches are very dense and relatively inactive, their power consumption is dominated by leakage power in current and future technologies. Hence, caches have become a major target for leakage power reduction techniques. Although high-Vt SRAMs (Static Random Access Memories) are used in low-end processors and FPGA (Field Programmable Gate Array) devices for low leakage, they are not commonly used in high-performance processors to meet the speed goal (particularly not for level 1 caches).

Cache arrays are typically divided into a number of smaller banks to reduce the delay. Many of the dynamic power reduction techniques take advantage of the fact that not all the banks are frequently accessed. These techniques allow only a limited set of banks to be active, and disable the rest by turning off components such as decoders, pre-charges and sense-amplifiers. However, such approaches alone have limited impact when the power dissipation is dominated by leakage. Thus, leakage reduction techniques also have been employed to turn off the unused banks to a low-leakage mode. Common leakage reduction techniques include gated-Vdd that utilizes stack effect by placing a high threshold transistor as a switch between memory cells and Vdd and/or ground lines, ABB-MTCMOS that dynamically increases the threshold voltages of the transistors in the memory cell by raising the source to body voltage of the transistors, and drowsy cache that reduces the leakage by dynamically decreasing the supply voltage. However, none of these techniques consider thermal effects as a design factor. In leakage dominant technologies, the exponential relationship between the leakage power and temperature makes the inclusion of the thermal behavior into the design process fundamentally important. In other words, current power reduction techniques for caches may not be fully optimized in the presence of thermal effects.

There exists a common misconception that thermal effects are not very important for caches since they are relatively cold spots of a chip. However, this is not true when majority of the cache power comes from leakage. FIG. 1 shows SPICE simulation results illustrating how the leakage power changes with temperature as well as the fractional or relative change in the leakage power due to a change in temperature at different temperature values. According to the data shown in FIG. 1, the fractional or relative change in the leakage power is actually larger for lower temperatures. That is, it has been known that the leakage power consumption has a superlinear relation to temperature. Therefore, previously it was assumed that the leakage power will become important only in components that have high operating temperatures and temperature-based optimizations mainly targeted such components (e.g., arithmetic-logic units). FIG. 1 shows that the relative increase in leakage power is higher in lower temperatures. Note that this does not claim that the absolute change is higher in lower temperatures; yet it is an indication that significant leakage power optimizations may be possible at lower temperatures. In other words, to get the same amount of power reduction, the necessary change in temperature is lower at the cold spots compared to hot locations (i.e. a 2° C. decrease in temperature will cause a larger fraction of power reduction at cold operating temperatures then at hot ones).

Thus, there is a need for systems and methods for thermal management of on-chip caches. There is a need for systems and methods for thermal management of on-chip caches using power density minimization.

### BRIEF SUMMARY OF THE INVENTION

Certain embodiments provide systems and methods for reducing power consumption in on-chip caches. Certain embodiments include Power Density-Minimized Architecture (PMA) and Block Permutation Scheme (BPS) for thermal management of on-chip caches. Instead of turning off entire banks, PMA architecture spreads out active parts in a cache bank by turning off alternating rows in a bank. This reduces the power density of the active parts in the cache, which then lowers the junction temperature. The drop in the temperature results in energy savings from the remaining active parts of the cache. BPS aims to maximize the physical distance between the logically consecutive blocks of the cache. Since there is spatial locality in caches, this distribution results in an increase in the distance between hot spots, thereby reducing the peak temperature. The drop in the peak temperature then results in a leakage power reduction in the cache.

These and other advantages and novel features of the present invention, as well as details of an illustrated embodiment thereof, will be more fully understood from the following description and drawings.

### BRIEF DESCRIPTION OF THE SEVERAL VIEWS OF THE DRAWING

FIG. 1 shows simulation results relating leakage power changes with temperature.

FIG. 2 illustrates an example of minimizing the power density of active parts in a cache.

FIG. 3 shows a flip-chip cache package.

FIG. 4 illustrates a one-dimensional chip thermal model circuit.

FIG. 5a illustrates a gated-Vdd circuit to reduce leakage power in memory cells in accordance with an embodiment of the present invention.

FIG. 5b shows PMA for a 4-way set-associative cache in accordance with an embodiment of the present invention.

FIG. 6 illustrates a PMA implementation for a 4-way set-associative cache in accordance with an embodiment of the present invention.

FIG. 7 illustrates BPS in a cache in accordance with an embodiment of the present invention.

FIG. 8 shows pseudo-code for generating a block permutation in accordance with an embodiment of the present invention.

FIG. 9 illustrates an example of conventional and rearranged cache decoder configurations in accordance with an embodiment of the present invention.

FIG. 10 illustrates a flow chart of a simulation process to estimate power and temperature.

FIG. 11 shows energy consumption of SGA and PMA architectures.

FIG. 12 shows normalized average dynamic and leakage power in different cache structures.

FIG. 13 shows average temperature of active banks in various cache structures.

FIG. 14 shows peak temperature of active banks in various cache structures.

FIG. 15 shows normalized energy of SGA and PMA with respect to different cache structures.

FIG. 16 shows normalized energy of SGA and PMA with respect to different cache structures.

FIG. 17 shows normalized energy of SGA and PMA with respect to different cache structures.

FIG. 18 shows normalized energy of SGA and PMA with respect to different cache structures.

FIG. 19 shows normalized energy of caches using BPS with respect to conventional caches.

FIG. 20 shows average and peak temperature of memory banks in conventional and BPS caches.

FIG. 21 depicts an exemplary floorplan for an Alpha 21364 core

FIG. 22 shows normalized energy of PMA with respect to different cache structures.

FIG. 23 illustrates a flow diagram for a method for reducing power consumption using a power density minimized architecture in an on-chip cache in accordance with an embodiment of the present invention.

FIG. 24 depicts a method for reducing power consumption using a block permutation scheme in an on-chip cache in accordance with an embodiment of the present invention.

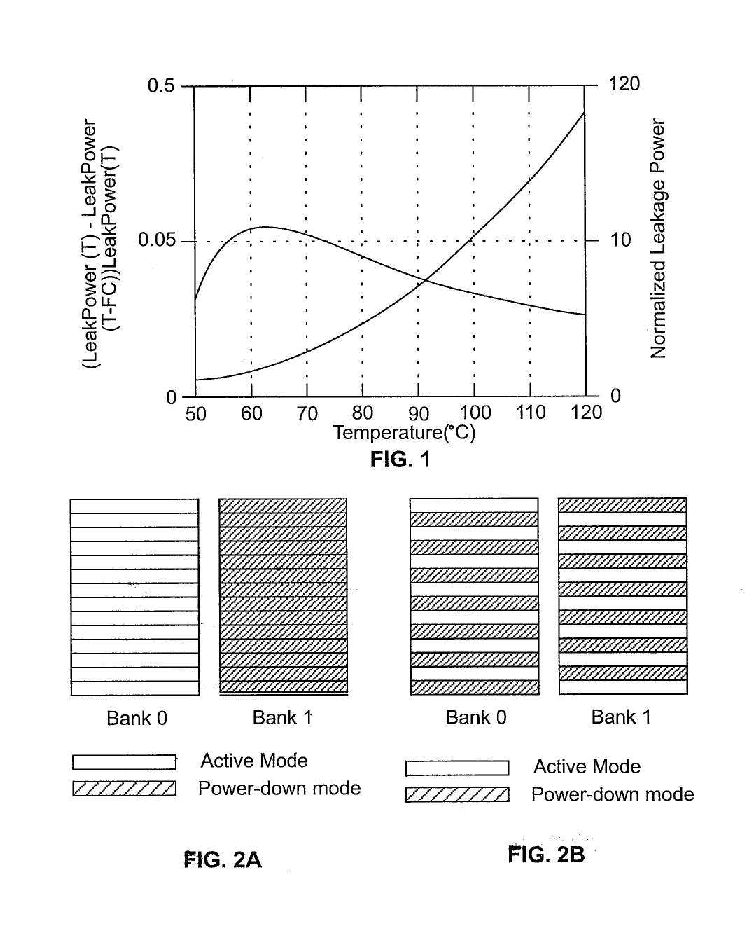

Table 1 shows characteristics of application used in simulations in accordance with embodiments of the present invention.

Table 2 shows information regarding a base processor configuration.

Table 3 illustrates PMA simulation data in accordance with embodiments of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide systems and methods for reducing power consumption in on-chip caches. Certain embodiments “intelligently” minimize or reduce the power density of cache “hot spots” and uses thermal effects to reduce the power. Certain embodiments include two techniques (referred as Power density-Minimized Architecture (PMA) and Block Permutation Scheme (BPS)) for thermal management of on-chip caches.

In certain embodiments, PMA enhances power-down techniques with power density (hence temperature) consideration of the active parts in the cache. Instead of turning off entire banks, PMA architecture spreads out the active parts by turning off alternating rows in a bank. This reduces the power density of the active parts in the cache, which then lowers the junction temperature. Due to the exponential relationship between the leakage power and temperature, the drop in the temperature results in energy savings from the remaining active parts of the cache.

BPS aims to maximize the physical distance between the logically consecutive blocks of the cache. Since there is spatial locality in caches, this distribution results in an increase in the distance between hot spots, thereby reducing the peak temperature. The drop in the peak temperature then results in a leakage power reduction in the cache.

Certain embodiments provide a thermal-aware cache power-down technique that reduces or minimizes the power density of the active parts by turning off alternating rows of memory cells instead of entire banks. The decrease in the power density lowers the temperature, which in return, reduces the leakage of the active parts (e.g., in some cases exponentially reduces the leakage). Simulations based on SPEC2000, NetBench, and MediaBench benchmarks in a 70 nm technology show that the proposed thermal-aware architecture can reduce the total energy consumption by 53% compared to a conventional cache, and 14% compared to a cache architecture with thermal-unaware power reduction scheme.

Certain embodiments provide a block permutation scheme that can be used during the design of caches to maximize the distance between blocks with consecutive addresses. Because of spatial locality, blocks with consecutive addresses are likely to be accessed within a short time interval. By increasing or maximizing the distance between consecutively accessed blocks, we reduce or minimize the power density of the hot spots in the cache, and hence reduce the peak temperature. This, in return, results in an average leakage power reduction of 8.7%, for example, compared to a conventional cache without affecting the dynamic power and the latency. In certain embodiments, cache architectures add little or no extra run-time penalty compared to the thermal-unaware power reduction schemes, yet they reduce the total energy consumption of a conventional cache by 53% and 5.6% on average, respectively, for example.

This trend implies that thermal effects can still have a significant impact on the power consumption of caches. In certain embodiments, thermal effects are considered to control the leakage power of on-chip caches. Particularly, certain embodiments provide thermal-aware cache architectures and thermal-aware architectural optimizations for caches. Certain embodiments improve the efficiency of existing power-down techniques for data caches and provide a low-power cache architecture for reducing or minimizing the thermal effects of spatial locality. Techniques reduce leakage power utilizing the idea of power density minimization. In other words, parts of a cache with high activity are systematically placed far away from each other in order to alleviate or reduce the hot spots in the cache. This, in return, reduces the leakage power consumption.

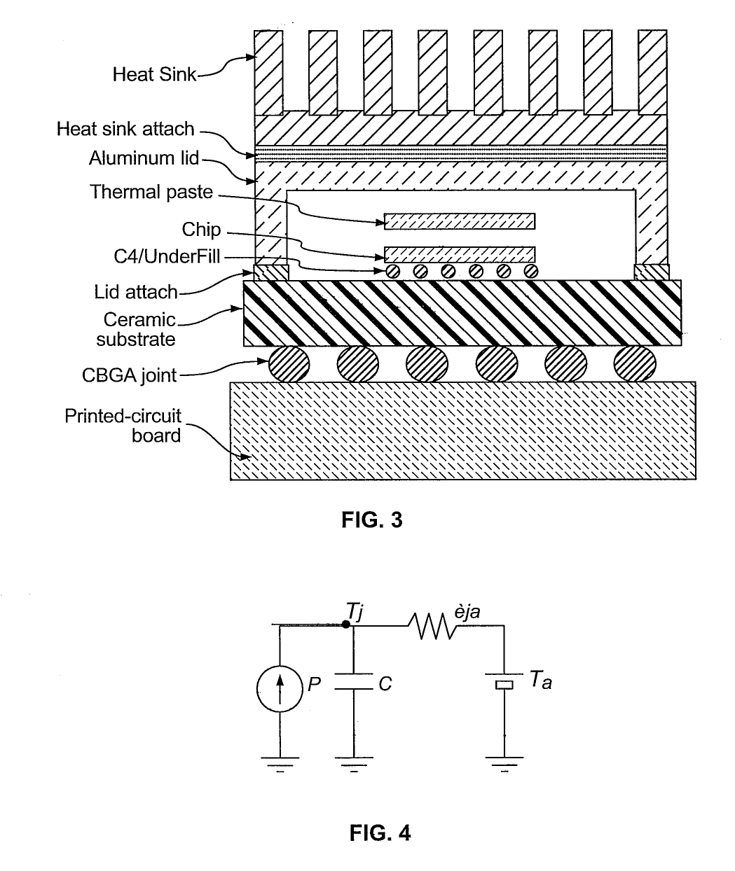

The existing power reduction techniques for caches can eliminate almost all the leakage power of the parts in power-down mode. However, the power of the active parts is still kept the same (high-leakage). Certain embodiments provide a cache architecture that reduces or minimizes power density of the active parts in the cache. FIG. 2 illustrates a simple example of this idea using two banks. In FIG. 2(a), Bank 0 is turned on while Bank 1 is turned off to save power as it is commonly done. On the other hand, FIG. 2(b) turns off alternating rows of both banks, thereby halving the power density of the rows that are in active mode. While the number of rows turned off is the same in both cases, the reduction in the power density in FIG. 2(b) lowers the junction temperature, resulting in an exponential reduction in the leakage of the active rows. Thus, the leakage power of the active rows is reduced in addition to the eliminated power of the inactive parts that are turned off. This proposed cache architecture is called Power density-Minimized Architecture (PMA) hereafter. Although the notion of PMA can be applied to different power reduction techniques, for purposes of illustration only, PMA is described below with respect to a scheme that combines selective cache ways and gated-Vdd as the example of a thermal-unaware power reduction technique. Specifically, a thermal-unaware scheme is modified with PMA to illustrate how the leakage and total power reduction is affected.

Certain embodiments reduce leakage power of caches utilizing their spatial locality. If a particular block is accessed, it is very likely that blocks that are logically neighbors to the accessed block will also be accessed soon. This spatial locality is one of the most important reasons why caches are developed in the first place. However, when thermal effects are considered, physical locality (or density) should be avoided. In conventional caches, logically neighboring blocks are also physically neighbors. Therefore, the spatial locality results in the power sources being concentrated in a small area in the memory bank, which raises the temperature of the hot spots. Certain embodiments provide a scheme that increases or maximizes the physical distance between blocks that are logically neighbors by permuting the physical location of blocks in the architecture. The power density of the hot spots is therefore reduced or minimized, and the leakage power is reduced. This scheme is called Block Permutation Scheme (BPS).

Power and Thermal Models

Power Dissipation.

Power dissipation in a cache memory can be subdivided into two major components:

P=P_{dynamic}+P_{leakage} (1).

Dynamic power, P_{dynamic} is the power consumed when a cache is accessed through charging and discharging capacitances, such as wordlines, bitlines, address lines, and data output lines. Previous studies have developed analytical models of the dynamic power for caches. The dynamic power in caches is becoming smaller compared to the leakage power as technology scales down, and it is temperature-independent unless the operating frequency is indirectly affected by the temperature.

Leakage power P_{leakage}, on the other hand, is increasing exponentially with technology scaling due to the decrease in the threshold voltage. The leakage current is dominated mainly by the sub-threshold current, which for each gate, is given by:

$${I}_{subthreshold} = μ {C}_{ox} ( \frac{W}{L} ) ( m - 1 ) {( \frac{kT}{q} )}^{2} {e}^{q ( {V}_{g} - {V}_{t} ) / mkT} ( 1 - {e}^{- q {V}_{ds} / kT} ) , \qquad ( 2 )$$

where μ is the mobility, COX is the oxide capacitance, and m is the body effect coefficient whose value is usually around 1.1-1.4. W, L, k, T, q, V_{g}, Vₜ and V_{ds} represent channel width, channel length, Boltzmann's constant, temperature, electronic charge, gate voltage, threshold voltage and drain-source voltage, respectively. The exponential increase in the sub-threshold current with temperature is due to the increase in kT/q (which is proportional to the sub-threshold slope) in Equation (2), and the decrease in the threshold voltage as the temperature is raised. The temperature sensitivity of the threshold voltage is about 0.8 mV/° C. in deep submicron technologies, for example.

Thermal Model

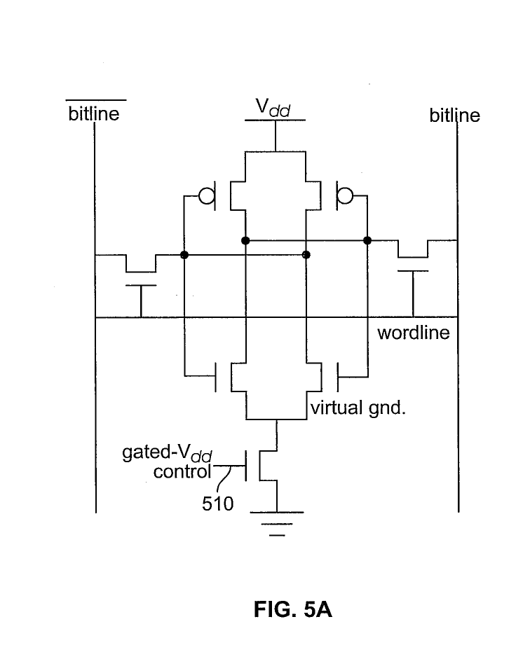

The heat generated from a chip is dissipated through the package. The heat flow in the package depends on many parameters such as geometry, flux source and placement, package orientation, next-level package attachment, heat sink efficiency, and method of chip connection. For example, FIG. 3 shows a flip-chip C4 package adapted from a model by Kromann. Most of the heat generated is conducted upwards through the silicon to the thermal paste, aluminum cap, heat sink attach, and heat sink, then convectively removed to the ambient air. In addition to this primary heat transfer path, there is also a secondary heat flow path by conduction downwards in parallel, through the C4 bumps and the epoxy underfill, ceramic substrate, lead balls to the printed-circuit board. However, since the heat removed through the secondary heat transfer path is usually small especially in a densely populated board, adiabatic boundary conditions are typically assumed on the four sides and the top of the chip, and only the primary heat transfer path is considered. Hence, the following one-dimensional heat equation is applied for a simple chip thermal model

θⱼₐcT′ⱼ+Tⱼ=P(Tⱼ)θⱼₐ+Tₐ (3),

where θⱼₐ is the chip junction-to-ambient thermal resistance of the silicon substrate and the package, c is the heat capacity of the system, Tⱼ is the chip junction temperature, Tⱼ is the time derivative of Tⱼ (i.e.

$$\frac{d {T}_{j}}{d t} ) ,$$

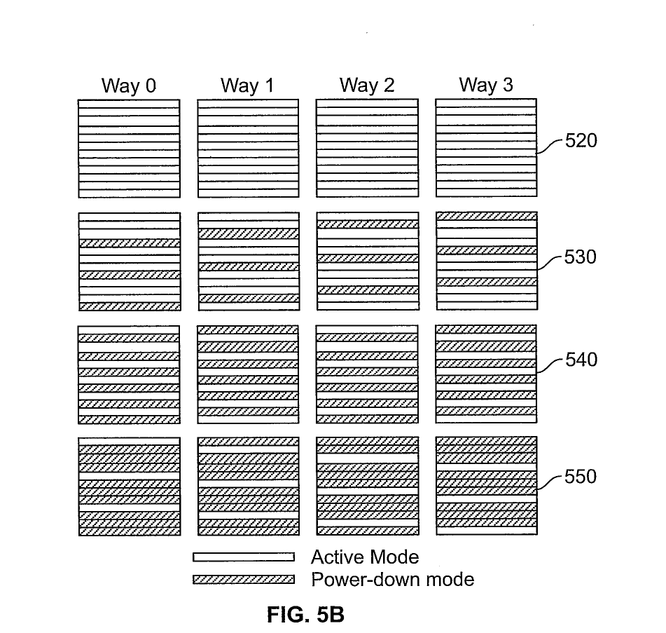

P is the chip power dissipation, and Tₐ is the ambient air temperature. FIG. 4 shows an equivalent electrical circuit for the thermal model. Note that power and temperature are functions of each other creating electrothermal coupling effect. A rise in the temperature results in an increase in the leakage power, which in turn, raises the temperature even higher, thus creating a positive feedback loop. Therefore, power and junction temperature have to be solved iteratively using Equations (2) and (3) until they both reach stable values in order to evaluate their transient behavior. If one just wants the steady-state values of the power and the junction temperature, Tⱼ is set to zero, and the final values can be found numerically using.

Tⱼ=P(Tⱼ)θⱼₐ+Tₐ (4).

The thermal resistances of the silicon, the aluminum cap, and the heat sink attach is small, and their contribution to the temperature drop can be omitted for a first-order analysis. Hence, the junction-to-ambient thermal resistance can be expressed as

θⱼₐ=θₜₕₑᵣₘₐₗₚₐₛₜₑ+θ_{heat sin k} (5).

In certain embodiments, thermal paste resistance is reduced as the chip area increases. This is because a thermal resistance can be written as

$$θ = {R}_{th} / A , \qquad ( 6 )$$

where Rₜₕ is the unit thermal resistance, and A is the cross-sectional area. An increase in the chip area directly increases the area of the thermal paste placed above it, thus assuming the chip area equals to the thermal paste area, Equation (4) can be rewritten as

$${T}_{j} = ( P ( {T}_{j} ) / {A}_{chip} ) {R}_{thermalpaste} + P ( {T}_{j} ) {θ}_{heat sin k} + {T}_{a} , \qquad ( 7 )$$

where P(Tⱼ)/A_{chip} represents the power density of the chip, and Rₜₕₑᵣₘₐₗₚₐₛₜₑ is the unit thermal resistance of the thermal paste. Convective thermal resistance of the heat sink, θheatsink is affected less by the chip area since the heat is usually spread out more uniformly (using a heat spreader) before it reaches the heat sink. However, in case of adapting an advanced fan heat sink as it is commonly done in today's technology, the heat sink resistance becomes small enough that the thermal paste resistance takes up the majority of the total junction-to-ambient thermal resistance (more than 60%). Therefore, reducing the power density of the chip can significantly lower the junction temperature.

A simple one-dimensional chip thermal model has been used above to explain the basic theory behind the proposed schemes. However, the heat transfer through lateral diffusion and the secondary heat transfer path to the printed-circuit board are also included and will be discussed below.

3. Thermal-Unaware Low-Power Cache Architecture (SGA)

In certain embodiments, as an example of low-power cache architecture that is thermal-unaware, selective cache ways and gated-Vdd technique are combined. Selective cache ways is employed to decide the optimum number of banks that will be enabled, and gated-Vdd is used to eliminate the leakage power in the disabled banks. This cache architecture is called Selective cache ways with Gated-Vdd Architecture (SGA). Note however, that application is not only limited to SGA: it can be applied to any general cache structure that uses power-down techniques for different banks or finer granularities. Existing cache architectures and power reduction techniques can be easily enhanced with the consideration of thermal effects to achieve significantly better power efficiency through power density minimization. Selective cache ways and gated-Vdd have been chosen as the underlying example due to their simplicity and popularity.

3.1. Selective Cache Ways

Selective cache ways disables a subset of the ways in a set-associative cache during periods of modest cache activity depending on how memory-intensive each application is. When a way is disabled, its decoders, pre-charges and the sense-amplifiers are turned off to eliminate the dynamic power. Due to the fact that it uses the array partitioning that is already present for performance reasons, only minor changes to a conventional cache are required, and thus the performance penalty is small. For each application, the optimum number of enabled ways is the case that consumes the lowest power for a given performance degradation threshold determined by the designer. For purposes of illustration, a performance degradation threshold of 2% is used for finding a number of enabled ways.

3.2. Gated-Vdd

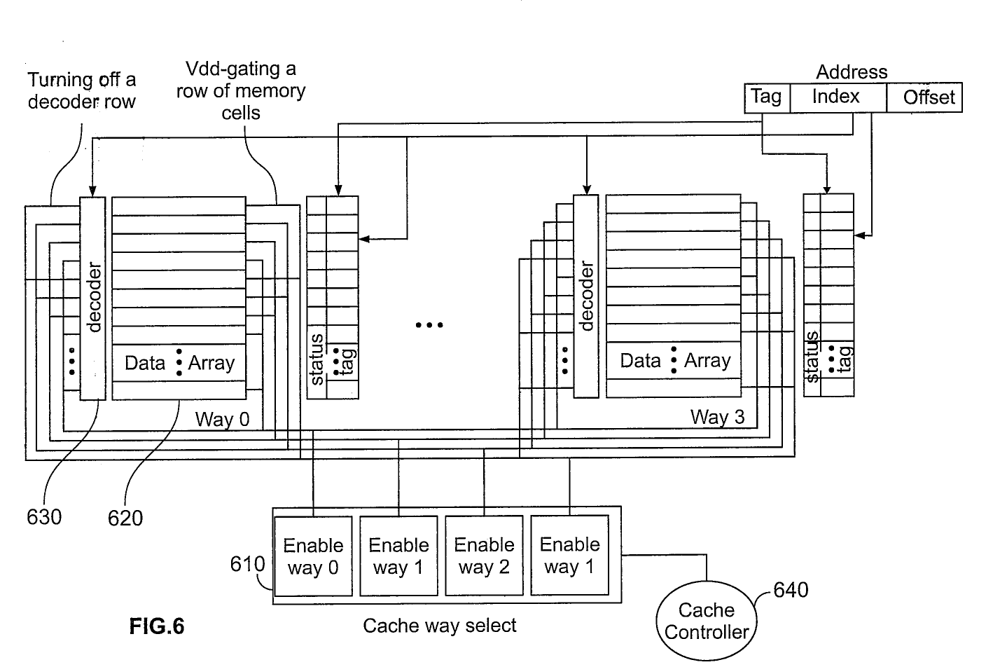

In gated-Vdd, an extra high-threshold transistor 510 is placed as a switch in the supply voltage or ground path of the memory cells, as shown in FIG. 5a. This extra transistor 510 is turned on when the section is being used, and turned off for lowpower mode. When the transistor 510 turns off, the leakage power is drastically reduced (practically eliminated). This is due to the huge reduction in the sub-threshold current by stack effect of self reverse-biasing series-connected transistors.

4. Power density-Minimized Architecture (PMA)

FIG. 5b shows how PMA works for a 4-way set-associative cache. Cache 520 illustrates use of PMA for a 4-way set-associative cache with 4 ways enabled. Cache 530 illustrates use of PMA for a 4-way set-associative cache with 3 ways enabled. Cache 540 illustrates use of PMA for a 4-way set-associative cache with 2 ways enabled. Cache 550 illustrates use of PMA for a 4-way set-associative cache with 1 way enabled.

Similar to selective cache ways, the optimal number of ways is first determined for each application. Then, the cache is configured for this selection of ways. Instead of disabling and enabling an entire bank, enabled rows are distributed in a way that minimizes the power density. Hence, PMA will have the same cache hit rates as the selective cache ways while the physical architecture has been modified. Although a scheme is described in which each application selects the number of ways statically, the turning on and off of the rows can even be performed dynamically within an application.

It was shown above that a decrease in the power density can significantly lower the junction temperature. The drop in the temperature reduces the leakage power of the enabled parts of the cache exponentially, which then decreases the temperature even further. This electrothermal coupling effect continues until both the power and the temperature reach the steady-state. The gate delay is also affected by a change in the temperature. There are two opposing factors that determine the temperature dependence of the gate delay. As the temperature is raised, the decrease in the saturation velocity increases the gate delay while the decrease in the threshold voltage improves it. However, as the supply voltage scales down to about 1V, the impacts of those two factors cancel out, thereby keeping the gate delay approximately constant with temperature. Therefore, additional power in the active parts of the cache can be saved without affecting the device performance (in fact, it improves slightly) by modifying the cache structure into PMA.

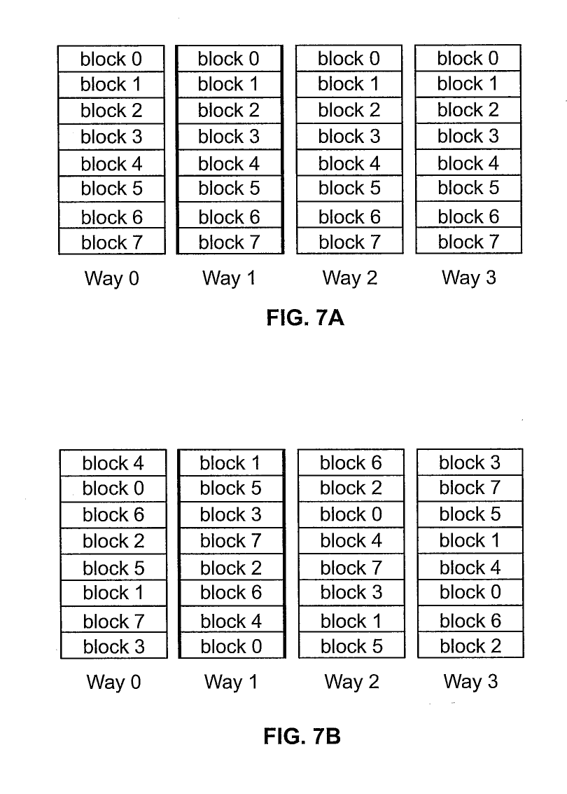

An implementation of PMA for a 4-way set-associative cache is shown in FIG. 6. The only addition made compared to SGA is in the power-gating scheme of the inactive memory cells and the decoders. Notice that each way requires four different enable signal lines 610 as inputs for Vdd-gating memory banks or cells 620 and the decoder 630 in PMA, whereas only one enable signal line is required for each way in SGA. In PMA, those enable signal lines are selected by the cache controller 640 such that the enabled parts of the cache are spread out as far as possible for different number of ways enabled. The increased number of enable signal lines for power-gating results in more capacitance to charge and discharge, which increases both the dynamic power and the delay. However, since the number of enabled ways is determined for different applications, those enable signal lines are switched only once in the beginning of an application, and stay unchanged until a context switch. Therefore, the extra dynamic energy consumed by the more complex enable signal lines in the beginning of an application becomes negligible. Likewise, the extra delay due to the increased capacitance of the enable signal lines is also negligible. There is some increase in the dynamic power in PMA compared to SGA since precharges and sense-amplifiers are no longer gated. However, this increase in the dynamic power was found to be insignificant from SPICE simulations of our layout, which will be discussed further below. It is also possible to tradeoff between complexity of the enable signal lines and power savings. In the 4-way associative cache example, power density of the active parts can decrease by a factor of up to four (when only one way is enabled as shown in FIG. 5b, part (d)). However, one may choose to have only two enable signal lines per way instead of four, which means that alternating rows in a bank are grouped together to turn on or off simultaneously. Hence, only cases like FIG. 5b, part (a) and part (c) are possible. In this case, power density of the active parts can decrease only by a factor of two even when only one way is enabled. If the number of enabled ways happens to be one quite frequently, it is more desirable to have four enable signal lines per way since it will decrease the power density of the active parts up to four times. On the other hand, there would be no reason to have four enable signal lines per way instead of two if the number of enabled ways is mostly two.

The design complexity of other power/delay optimization techniques such as wordline and bitline partitioning is not affected by PMA. As depicted in FIG. 6, a conventional cache architecture is changed by gating the ground or Vdd for each row in the data arrays and the decoders. Hence, the PMA scheme can be applied to any cache design.

FIG. 6 depicts the high-level operation of the PMA. PMA is built on top of a power-down technique (called SGA throughout the paper) where a set of cache ways can be turned-off to reduce the power consumption (dynamic as well as leakage). Looking at FIG. 6, PMA is based on the idea of turning off cache ways with an important modification. In SGA, each enable signal would be connected to a separate cache way. Instead, in PMA, each signal is connected to a set of cache blocks spanning all the cache ways. This new connection achieves the desired power-density minimization shown in FIG. 5. Note that, detecting whether a microprocessor implements such a scheme would be fairly straightforward. First, the enable signals have to be visible externally (either to software or to other hardware components performing the power management). In addition, a simple look at the layout will reveal that the enable signals are connected to each cache way, implementing the “spanning” (i.e., power density minimization) described in this publication.

5. Block Permutation Scheme (BPS)

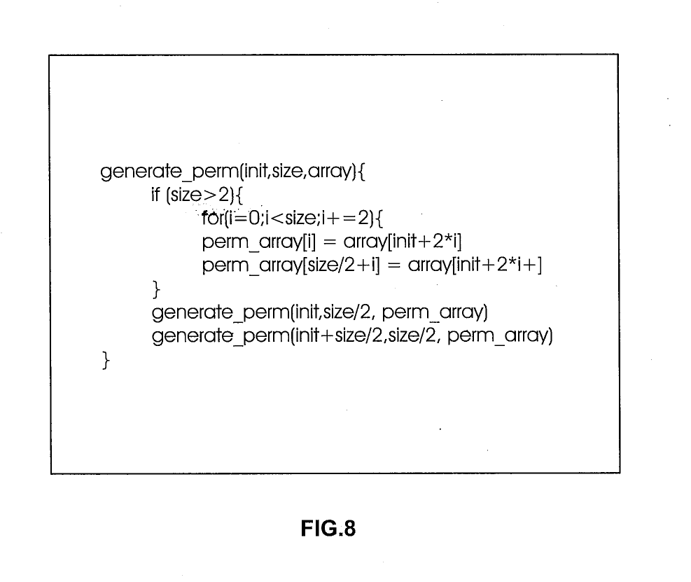

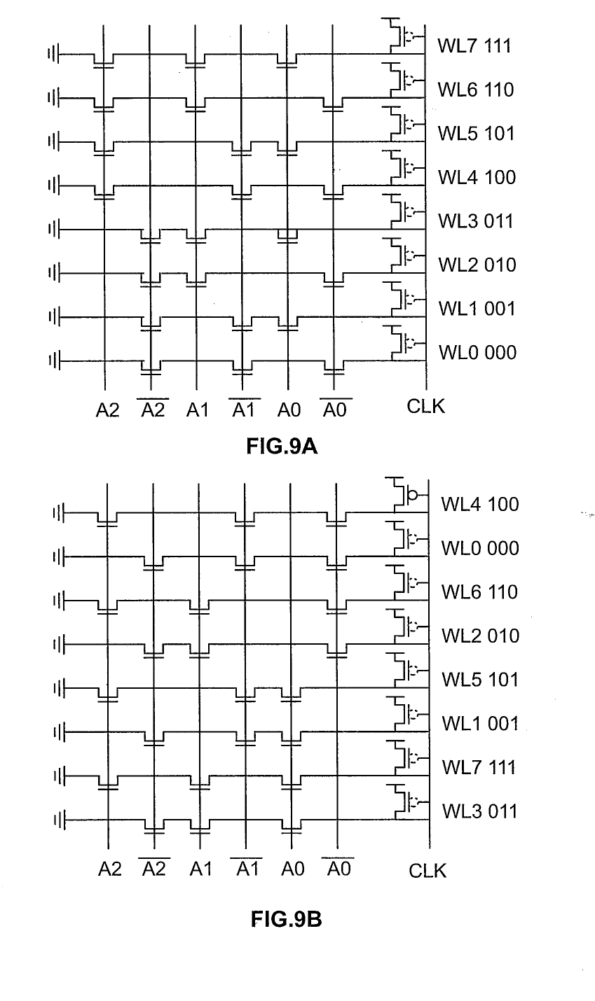

The second temperature-aware power optimization scheme is called Block Permutation Scheme (BPS). An example of BPS is illustrated in FIG. 7. In BPS, a permutation of the physical locations of blocks is generated such that the average distance between logically neighboring blocks is maximized. FIG. 7(a) shows a conventional cache addressing scheme where the distance between logically neighboring blocks is always 1. On the other hand, a permutation of these blocks as shown in FIG. 7(b) increases the average distance between logically neighboring blocks to roughly 4 in this example. Note that, the distance between two consecutive blocks is increased as well as the area of a working set, which is formed by a number of consecutive blocks. In other words, certain embodiments aim to place a number of logically consecutive blocks as far away from each other as possible. For example, consider a loop that works on 4 consecutive blocks. Since these 4 blocks will be accessed over and over again, certain embodiments try to maximize the distance between all, or tries to make the total area covered by them as large as possible. For the same example, while all possible sets of 4 consecutive blocks cover an area of 4 in the conventional cache, the 4 consecutive blocks in our scheme cover 7.6 blocks on average. The pseudo-code to generate the permutation for each way is given in FIG. 8. This function generates the permutation for the block numbers between init and init+size−1 in the memory bank array. For a bank with n blocks, the recursive function will have log 2(n) levels. To further reduce the power density of the hot spots, the input is shifted with a different offset for each way (by three in the example). This way, certain embodiments can help make sure that the blocks that are physically next to each other do not correspond to the same logical rows, and thus are not accessed simultaneously.

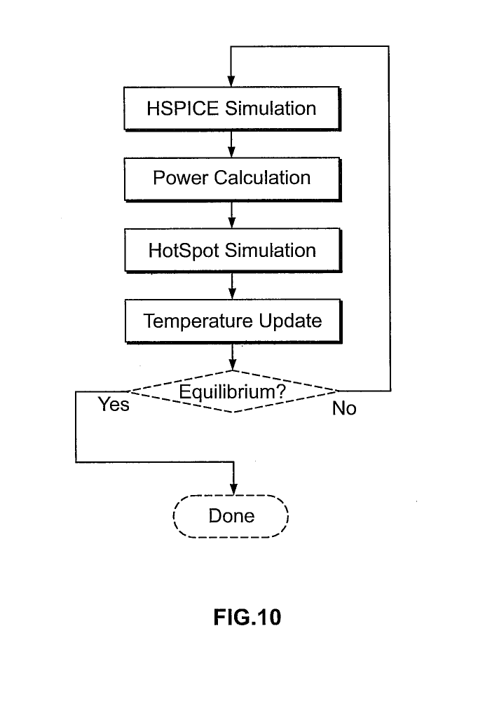

BPS results in a temperature drop in the hot spots, but also a temperature rise in the relatively colder parts in the bank. In other words, it distributes the active blocks more uniformly, which in return results in reduction in the overall peak temperature. Because of the exponential temperature dependence of the leakage power, the total energy of the bank is reduced although the leakage power of the relatively colder parts in the bank is increased. Note that BPS has little or no effect on the latency of the cache and the dynamic power, because it only requires a rearrangement of the decoders without adding any hardware. An example of such rearrangement of the decoder is shown in FIG. 9.

6. Simulation Results

6.1. Simulation Setup

To investigate the performance of the proposed techniques, SPEC2000, NetBench, and MediaBench applications were simulated using the SimpleScalar 3.0 simulator. Important characteristics of the applications used in the simulations are presented in Table 1. Simulations used a number of ways to enable for each application as done by Albonesi under performance degradation threshold of 2%. The baseline processor configuration is described in Table 2. In the simulations, 4-way and 8-way set-associative caches were used to observe the effectiveness of PMA and the BPS. Particularly, a 64 KB 4-way associative cache and a 64 KB 8-way associative cache with 32-byte block sizes were targeted. The simulations selected 64 KB level 1 instruction and data caches to mimic the Alpha 21364 architecture. Simulations were performed for level 1 data and instruction caches with these configurations. However, the energy consumptions of the instruction caches were not affected by the PMA, because associativity could not be reduced without a significant impact on performance. These results are similar to the study by Albonesi. Similarly, the BPS optimization did not change the energy consumption of the data caches because of the relatively low level of spatial locality observed. Therefore results for data cache optimizations are presented using PMA and instruction cache optimization by BPS.

Table 3 shows an optimum number of enabled ways for each application obtained from the simulations, the increases in runtime when only the optimum number of ways were enabled, and the relative energy-delay product after applying PMA for the 64 KB data caches. It can be seen that on average, about half the ways can be disabled for the 4-way set-associative cache, and about five ways can be disabled for the 8-way set-associative cache. The number of accesses for each row in the memory bank was recorded during simulations. For all the programs, the simulator was run for 300 million instructions from each application with fast-forwarding application-specific number of instructions determined by Sherwood et al.

To measure the change in the temperature, the activity (hit and miss) of each block was recorded in epochs of 10 million cycles. Then, for each of these intervals, the steady-state temperature was found (using an iterative method that is described in the next paragraph). Note that the term “steady-state temperature” as used herein does not imply the temperature when t→∞, but rather it is the temperature reached after including interdependency with the leakage power for a given interval. The selection of the interval length (10 million) lies in the nature of the heat transfer. The thermal time constant is usually in the range of milliseconds, which is significantly bigger than the cycle time. Therefore we need to select a relatively large interval. However, if the interval is too large, transient behavior may be lost. Therefore, 10 million cycles (10 milliseconds for a 1 GHz machine) was selected, because it exhibits the optimum point for being able to observe the transient behavior as well as the thermal dissipation.

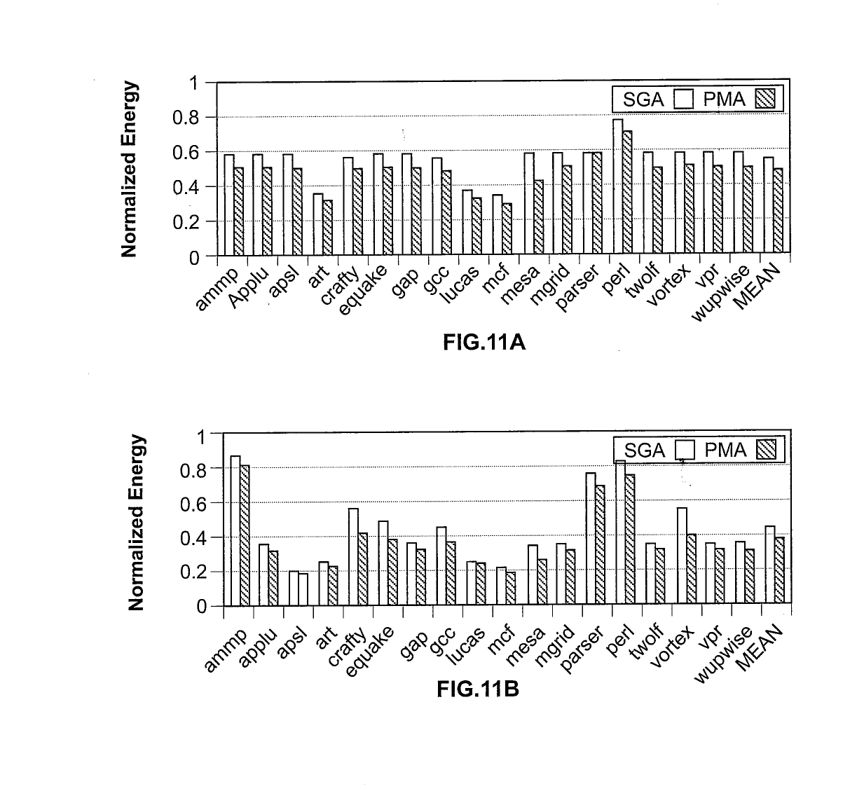

According to CACTI 3.2, the optimum number of banks for both 4-way and 8-way set-associative 64 KB cache is eight, each consisting of 256×256 bits. Hence, a 256×256 bit memory bank was laid our for 70 nm BPTM technology for three cases: conventional cache, SGA, and PMA. Note that, the properties of the BPS is identical to the conventional cache, hence a separate layout was not generated for it. Then, the dynamic power of each component in the memory bank was estimated using HSPICE simulations of the layout and the cache event information obtained from SimpleScalar simulations. The leakage power of the memory cells is also obtained from HSPICE simulations. For components outside a bank such as the output driver and the tag side components, CACTI 2.3 was used to estimate their power consumption. Conventionally, leakage power of a cache has been calculated for a constant temperature (e.g. 27° C. or 100° C.). However, this may create large errors especially in leakage dominant technologies due to the electrothermal coupling effect explained in the previous sections. Therefore, the coupling between power and temperature has to be taken into account for more accurate leakage power estimation. An iterative method was used to numerically determine the steady-state power and temperature. HotSpot was used to estimate the temperature of each row in a memory bank. Separate power consumption value was calculated for each row in a memory bank in order to include the effect of lateral heat diffusion between different rows within the bank. During SimpleScalar simulations, for example, the activity in each cache row is recorded. Based on these values, the power consumption of each row is determined and fed into HotSpot in order to include the effect of lateral heat diffusion between different rows. In each iteration, HSPICE is run to obtain the leakage power at a given temperature, then a new temperature value is obtained using HotSpot with the new power value calculated. This new temperature is fed back into HSPICE simulation of the next loop as the temperature parameter to calculate the new leakage power. The iteration ends when both power and temperature reach equilibrium. The flowchart of the simulation process is illustrated in FIG. 10.

6.2. Evaluation of PMA

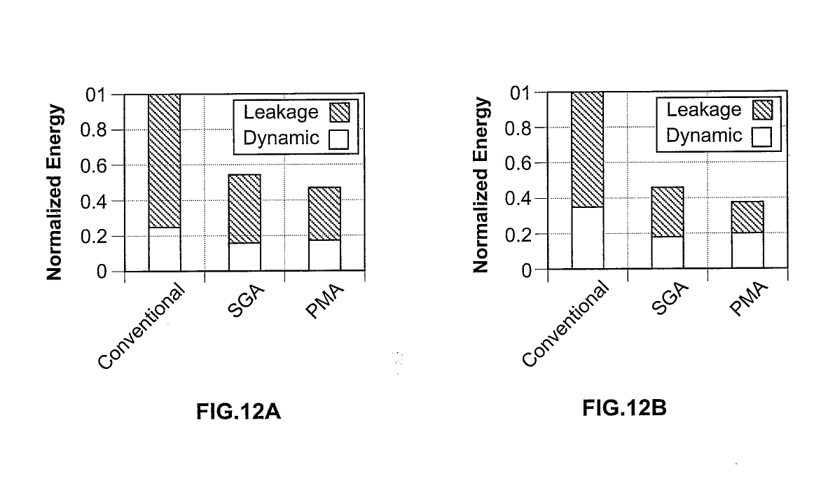

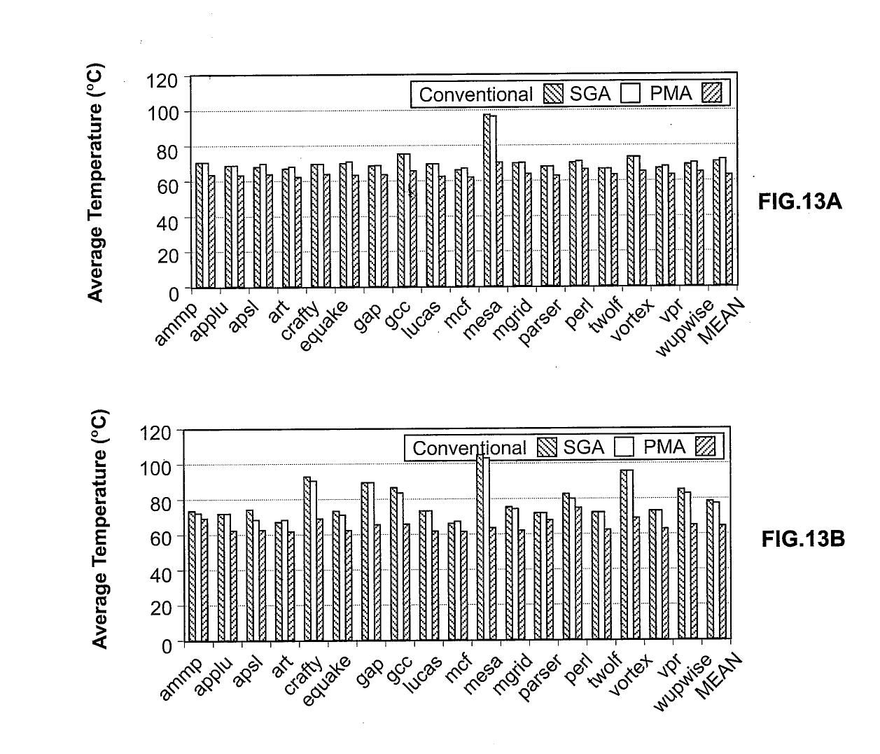

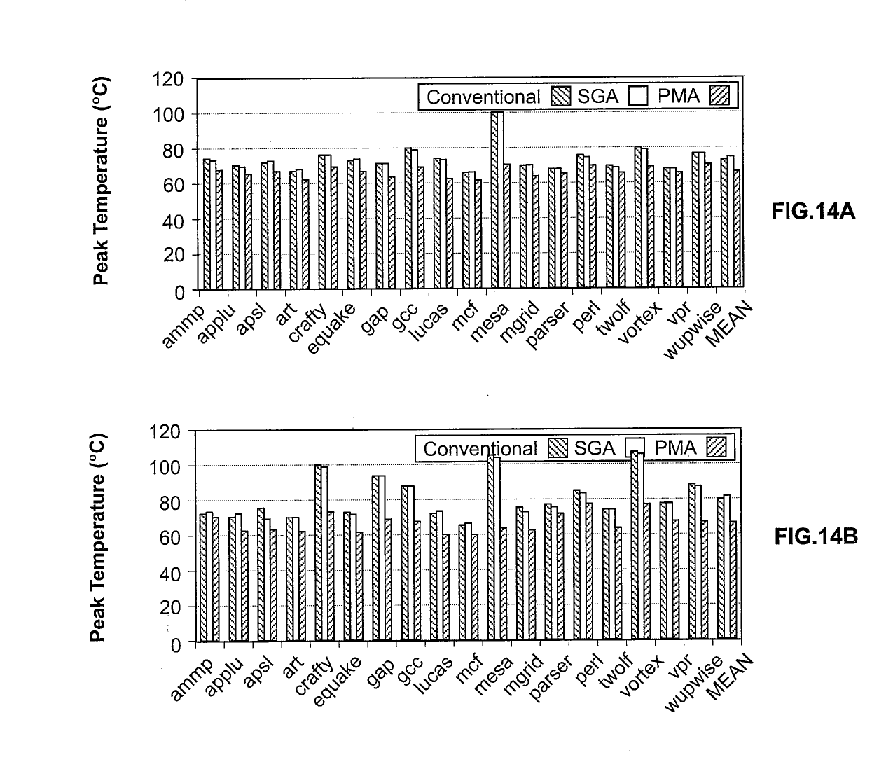

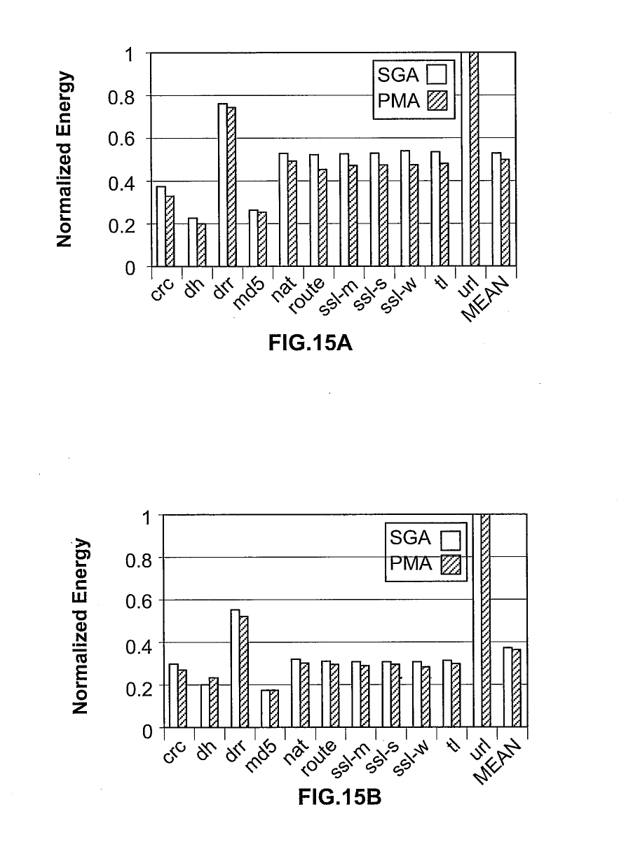

FIG. 11 presents the energy consumption of the SGA and PMA architectures with respect to the conventional cache for 64 KB 4-way and 8-way set associative data caches with the simulated applications. FIG. 12, on the other hand, shows how the dynamic and the leakage components of the energy changes on average for the three different cache structures. FIGS. 13 and 14 present the average and peak temperatures of the active banks, respectively. The change in the temperature is a reason for the energy reduction. When both the average and the peak temperatures are studied, SGA does not change the temperature significantly compared to the conventional cache. For SGA, there are three forces in action. First, since some of the banks are closed, the total power consumption is reduced and parts of the heat generated by the active banks will dissipate into neighboring disabled banks, having a positive effect on the temperature. In addition, since the execution times are also increasing, the total power consumption and hence the temperature tends to decrease. Third, since some of the banks are closed, the number of accesses to the active banks increases (due to an increase in the miss rates), having a negative impact on the temperature. Note that since way-prediction schemes are not used in the conventional cache, all ways are accessed in parallel. Therefore, when some banks are disabled, the change in activity in the enabled banks is not drastic. Nevertheless, in many applications, this increase is large enough to cancel out the positive effects of turning off banks. As a result, peak temperature is reduced by less than 1.5% by the SGA compared to the conventional cache, for example. Overall, for the 4-way set-associative cache, it can be seen that on average, about 45% of the total energy can be saved using SGA. For the PMA, on the other hand, temperatures significantly decrease. By adapting PMA, over 23% of the remaining leakage power is further reduced due to thermal effects. Also, there is little or no additional run-time increase due to PMA. Although the dynamic power increases about 10% from SGA to PMA because of not gating precharges and sense-amplifiers, the reduction in the leakage power in PMA results in an overall decrease in the total energy by 14% and 53% compared to SGA and the conventional cache, respectively.

The leakage reduction for PMA relative to SGA is higher with the 8-way set associative cache (32%) compared to that of the 4-way set-associative cache. This behavior is caused by the fact that the power density can be decreased by a factor of up to eight. In addition, the temperature of the 8-way set-associative caches is usually higher which means there is more room for the temperature to drop. However, the total additional energy is about 13%, which is actually lower than that of the 4-way set-associative cache. This is because, for example, in 8-way set-associative cache, SGA itself eliminates about 55% of the total energy of the conventional cache by disabling more than half the ways on average, thus not leaving much room for further leakage reduction by PMA. Furthermore, the penalty in the dynamic power also becomes relatively more significant as more ways are disabled. It can be seen from the results that the adaptation of PMA is most effective when approximately half of the ways are enabled. In summary, certain embodiments of the PMA scheme reduce the energy-delay product of the processor by 6.4% and 7.5% on average for 4-way and 8-way associative caches, respectively, for example. In addition, for the 256×256 bit memory bank used in simulations, the area increase was 4%, and the latency overhead was 3.5% for both SGA and PMA. The relative energy-delay products for each application with respect to the conventional cache are presented in Table 3. On the other hand, the energy consumption of the instruction caches was not affected by PMA for SPEC2000 applications because associativity was not reduced without an impact on performance.

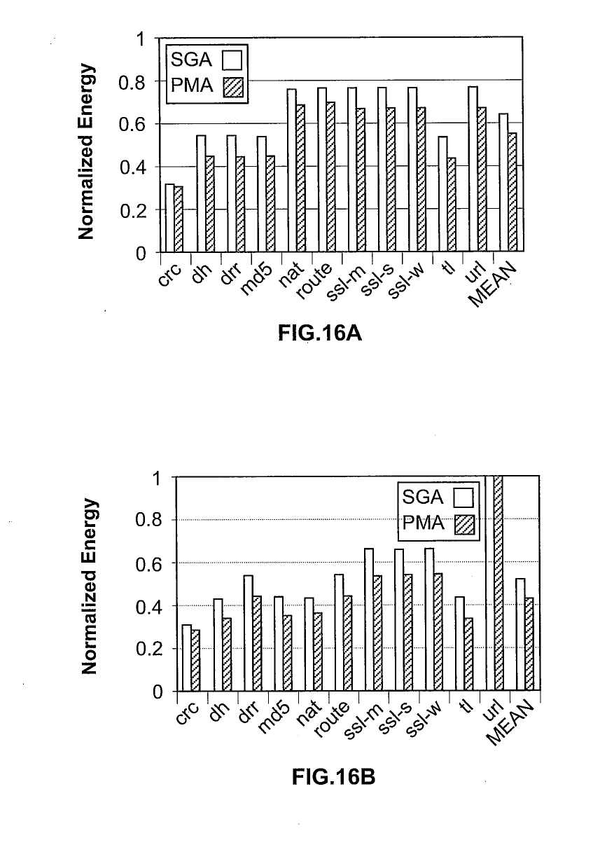

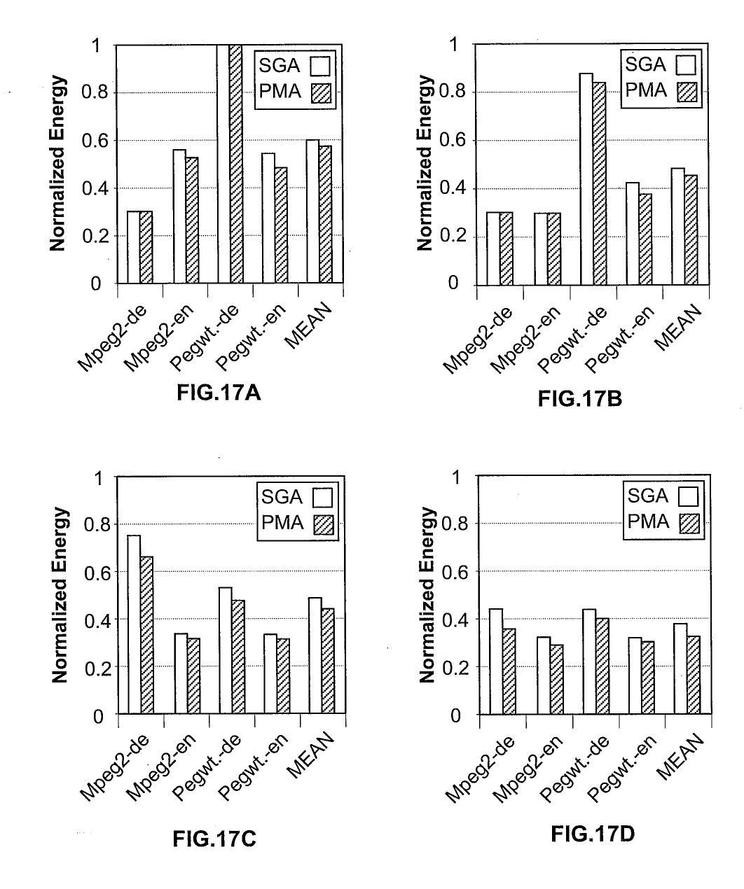

In order to study the effectiveness of PMA for applications other than SPEC2000, NetBench and MediaBench applications were also included in simulations. In contrast to SPEC2000 applications, the simulation results showed that for NetBench and MediaBench applications, PMA can be applied to 64 KB instruction caches as well. FIGS. 15 and 16 show the changes in the cache energy consumption for 64 KB 4-way and 8-way set-associative data and instruction caches when NetBench applications are used. It can be seen that for NetBench applications, PMA works very effectively for instruction caches. The code size of NetBench applications is relatively small compared to those of SPEC2000 applications. Hence, in a 64 KB cache, more than half of the ways can be disabled on average without a significant impact on the performance, even for instruction caches.

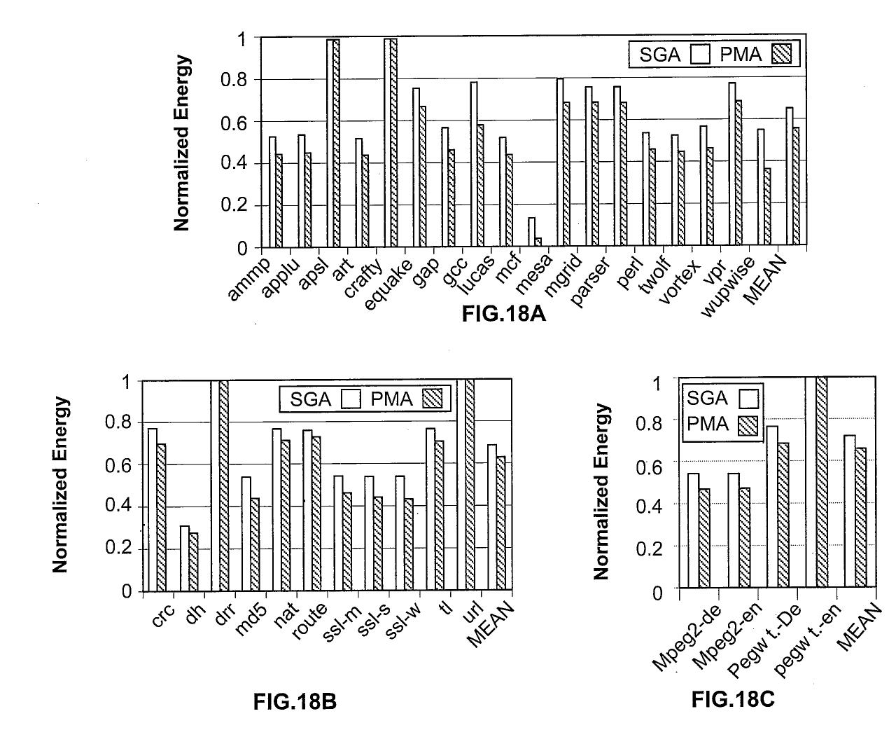

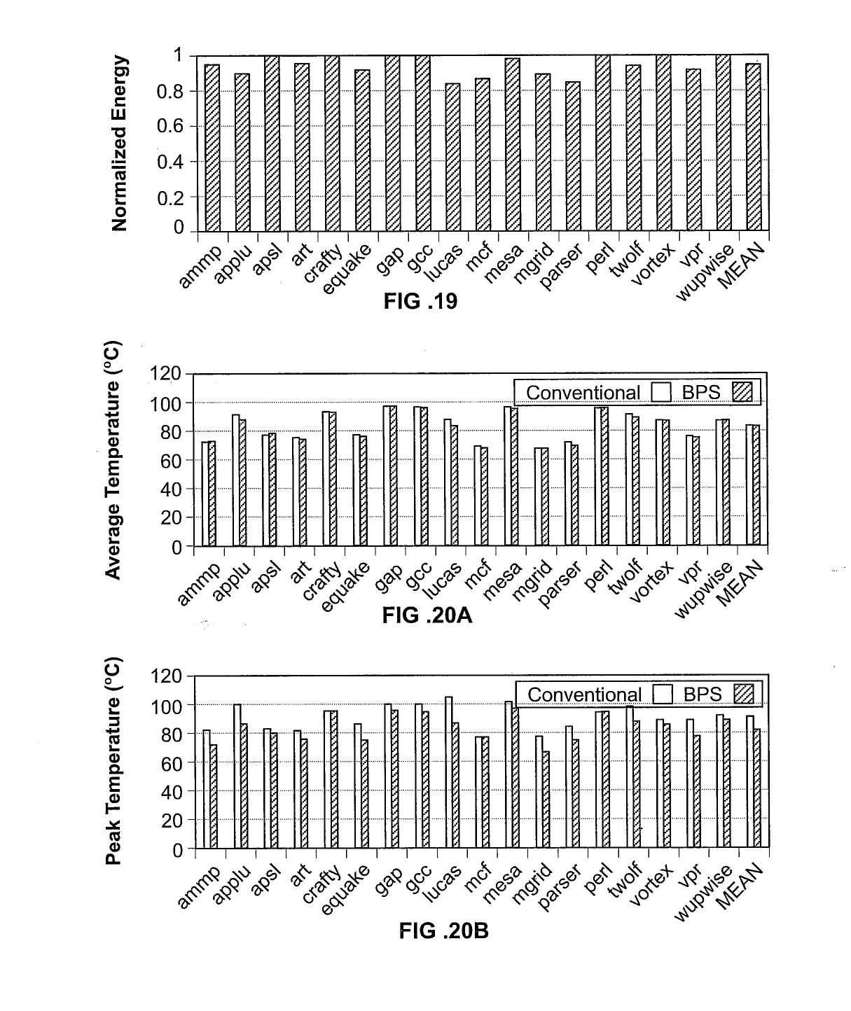

The simulation results for 64 KB 4-way and 8-way set-associative caches with MediaBench applications are also presented in FIG. 17. It can be seen that PMA does not result in much extra energy reduction compared to SGA for MediaBench applications. This ineffectiveness is caused by the fact that for many MediaBench applications, either most of the ways or almost none of the ways may be disabled, which deviates from the optimal case where approximately half of the ways are disabled. Simulations were also carried out for 16 KB data caches in order to observe the sensitivity of the PMA on smaller caches. It can be seen in FIG. 18 that the change in the cache size does not affect the effectiveness of PMA, and a similar kind of behavior is observed. For example, in case of the 16 KB 4-way set-associative data cache with SPEC2000 applications, PMA improves the total energy consumption by 13.6% and 43.6% compared to SGA and the conventional cache, respectively.

6.3. Evaluation of BPS

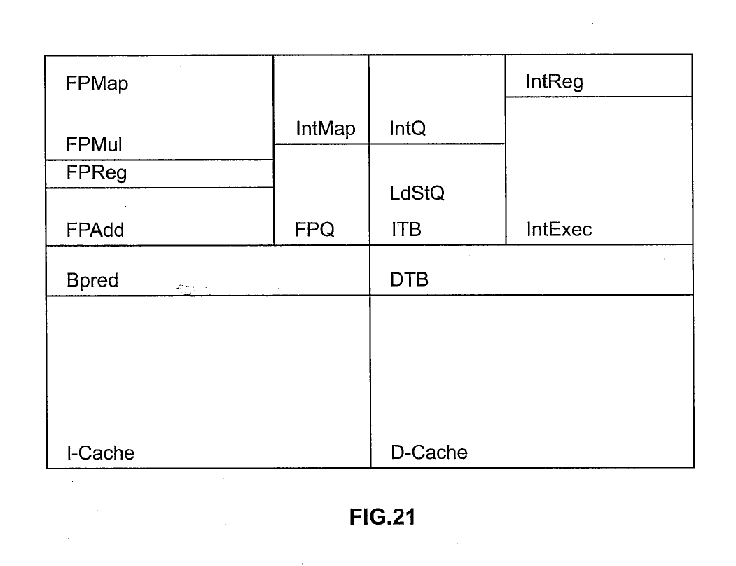

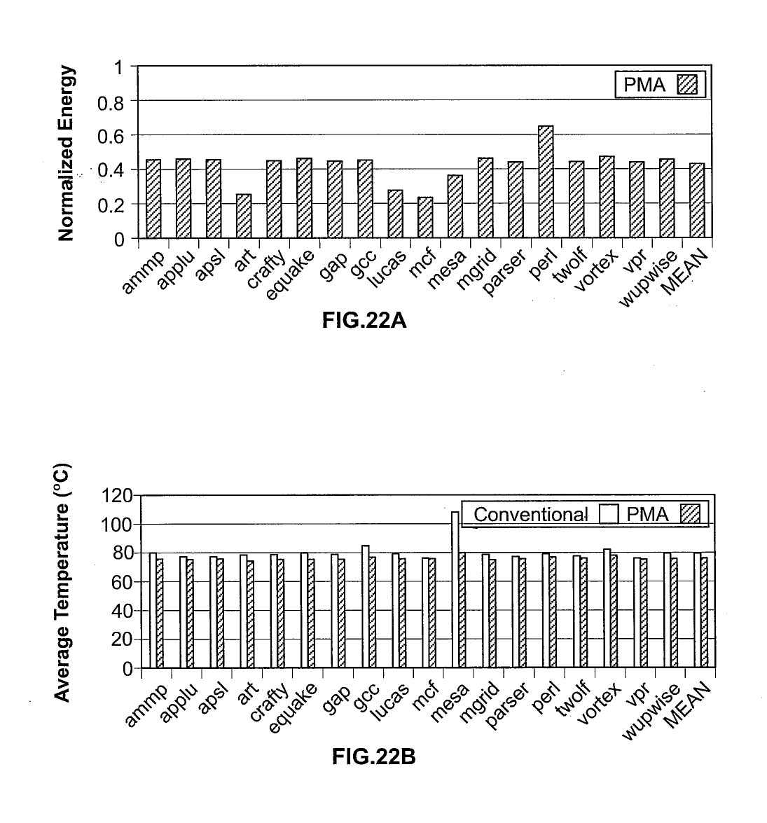

The effectiveness of BPS is illustrated in FIG. 19, which presents the energy consumption of the level 1 instruction cache enhanced with BPS relative to a conventional cache. Note that this optimization has no overhead (in terms of both execution time and cache latency). Since the dynamic power stays the same for both cases, any change in the total energy consumption is caused by the reduction in the leakage energy. It can be seen that BPS can be very effective for some applications such as lucas, mcf, and parser where the total energy is reduced up to 16%. Since permuting the blocks does not always guarantee a better power density compared to the conventional case, it may not always improve the energy. In fact, in case of apsi, the total energy actually increases by 1%. In general, BPS is useful when there is strong spatial locality in instruction sequences. Since most applications exhibit this property, generally we observe a reduction in the total energy consumption. On average, the leakage power and the total energy are reduced by 8.7% and 5.6%, respectively. FIG. 20 compares the temperature of the banks for the conventional cache and the cache with BPS. It is interesting to notice that the average temperature does not change very much while the peak temperature drops more significantly for the cache with BPS. This is because in memory banks of conventional instruction cache, hot spots are close to each other, thereby pushing up the peak temperature of the bank. In the cache with BPS, the power density of the hot spots is minimized through a more uniform distribution of the power dissipation sources, and thus the peak temperature is significantly lowered. Particularly, the BPS reduces the peak temperature about 7° C. on average. The drop in the peak temperature results in the leakage reduction of the hot spots, decreasing the overall leakage power in the bank.

It was observed through simulations that BPS does not result in a significant energy reduction in data caches for SPEC2000 applications, and both data and instruction caches for NetBench and MediaBench applications. The ineffectiveness of BPS in data caches is due to the fact that the benchmarks consist of streaming applications with large datasets, and thus sweep more or less the whole cache rather than accessing only a subset of the cache rows. As for the instruction caches with NetBench and MediaBench applications, the size of these applications is relatively small compared to that of SPEC2000 applications. Hence, even if the location of the cache accesses is not permuted, the impact of spatial locality on the bank temperature is not as significant.

6.4. Evaluation of Cache Power Density Minimization in Presence of Neighboring Blocks

The results presented in Sections 6.2 and 6.3 are based on an isolated cache. In this section, the effectiveness of cache power density minimization in the presence of neighboring blocks is studied. Since caches are known to have a relatively low power density compared to other blocks on a chip, there exists a misconception that the thermal profile of caches does not strongly depend on its own power density, but that of other “hot” blocks around it. However, there are two main reasons why the power density of caches, despite being relatively low, still has a significant impact on its thermal profile. First, lateral heat diffusion on a chip is much smaller compared to vertical heat dissipation through the substrate. Second, caches have a large area, and with the scaling of technology, more area is being devoted to caches compared to other blocks on a chip.

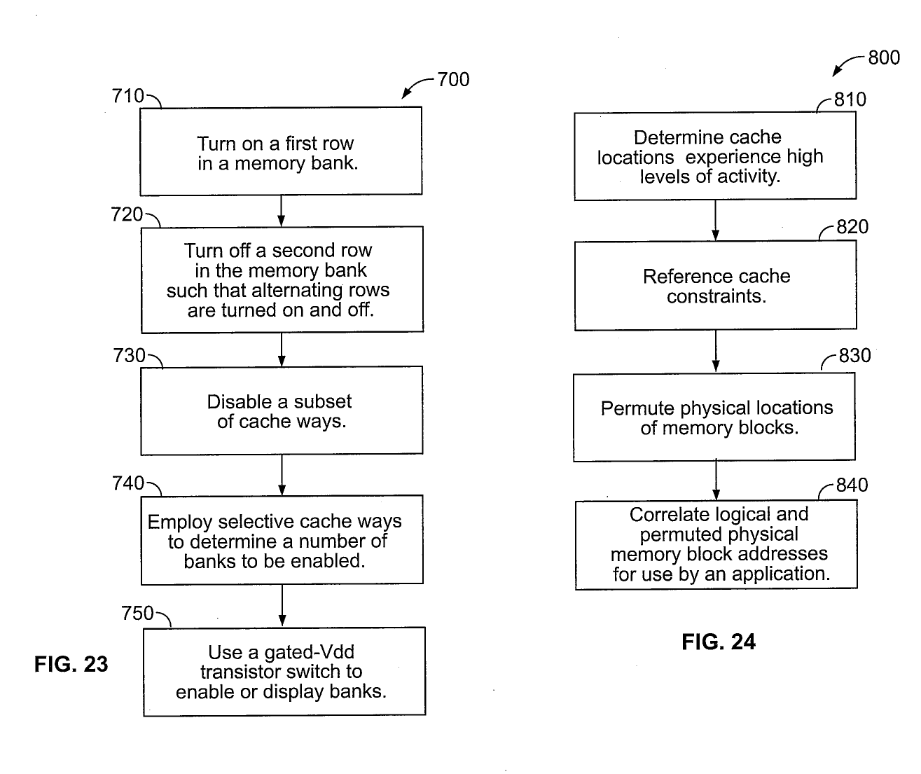

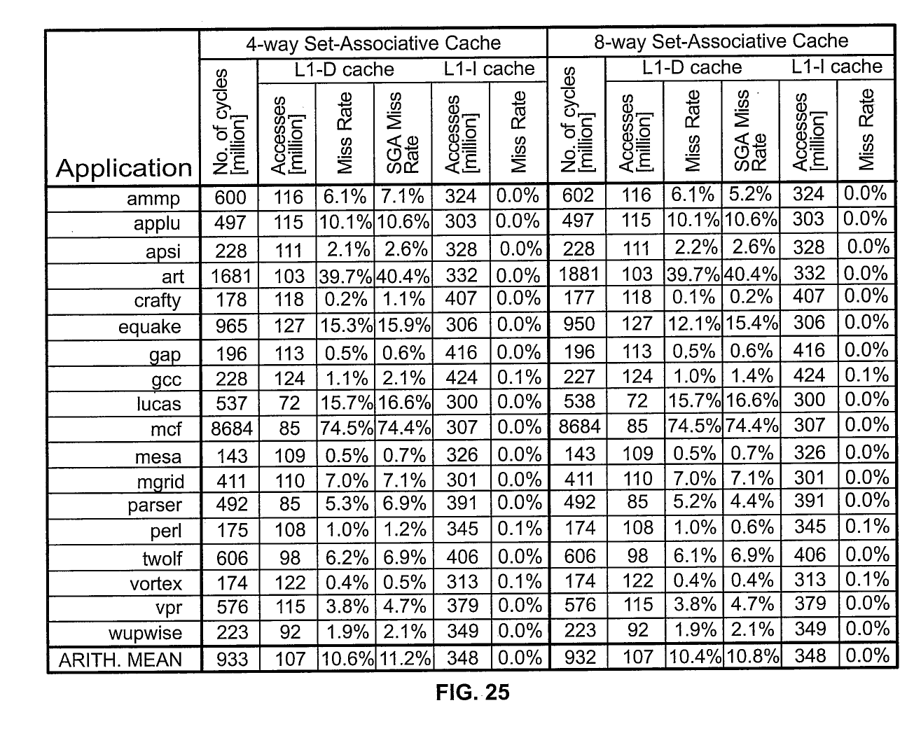

As a result, the internal power density of caches has an important impact on their temperature. In order to quantitatively verify the effectiveness of cache power density minimization in the presence of neighboring blocks, simulations have been carried out using 64 KB 4-way associative data cache with PMA as an example on the floorplan of an Alpha 21364 core shown in FIG. 21 (the cache is divided into individual rows in the actual floorplan used for simulation) and SPEC2000 applications. FIG. 22 shows the results for 0.64 KB 4-way set-associative data cache. It can be seen in FIG. 22 that the average temperature of the cache is higher than that of the isolated case (see FIG. 13) in both conventional cache and PMA due to the heat from the neighboring blocks. However, there is still a 5.0° C. drop (on average) in the cache average temperature when PMA is used. Although this drop is a bit smaller compared to that of the isolated case (due to the lateral heat diffusion), the total energy reduction is actually greater since the starting temperature of the cache is higher, which makes the leakage power a larger fraction of the total energy consumption. In particular, PMA reduces the total energy consumption by 57.7% compared to a conventional cache.

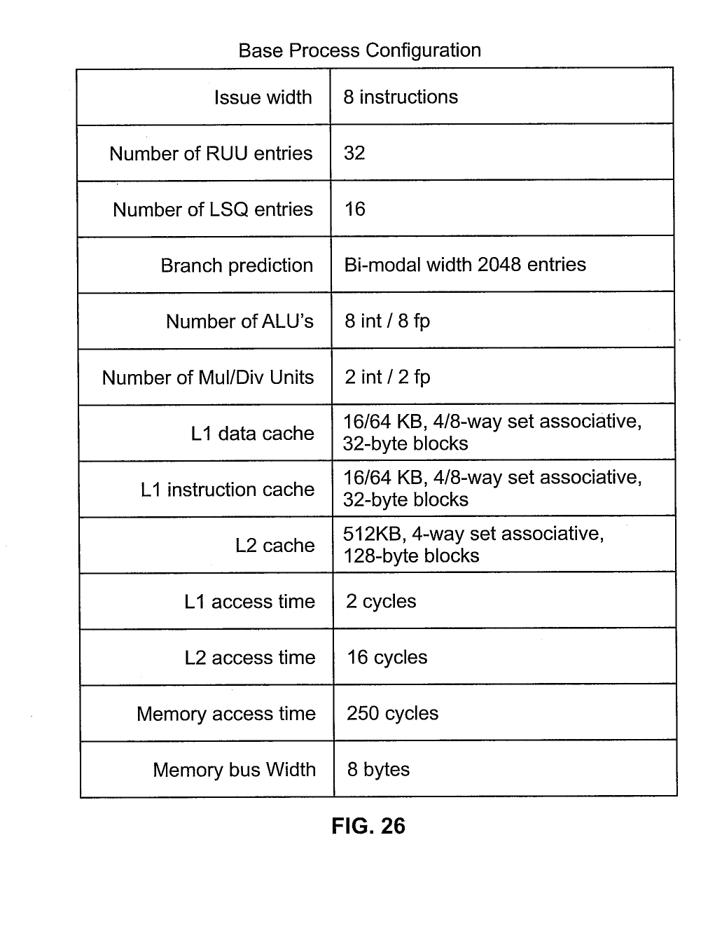

FIG. 23 illustrates a flow diagram for a method 700 for reducing power consumption using a power density minimized architecture in an on-chip cache in accordance with an embodiment of the present invention. As described above, at step 710, a first row in a memory bank in an on-chip cache is turned on or activated. At step 720, a second row in the memory bank in the on-chip cache is turned off such that alternating rows in the memory bank of the on-chip cache are turned off rather than the entire memory bank to reduce power density of active parts of the on-chip cache.

At step 730, a subset of ways in the cache are disabled during periods of modest cache activity. Disabled may be based on a particular application or applications being executed, for example. At step 740, selective cache ways is employed to determine a number of banks in said on-chip cache that will be enabled. Additionally, at step 750, a gated-Vdd transistor switch is used to help eliminate the leakage power in the disabled banks, wherein a high threshold transistor is placed as a switch in a supply voltage or ground path of memory cells in the memory banks of the on-chip cache, the transistor being turned on when the section is being used and turned off for low power mode.

One or more of the steps of the method 700 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

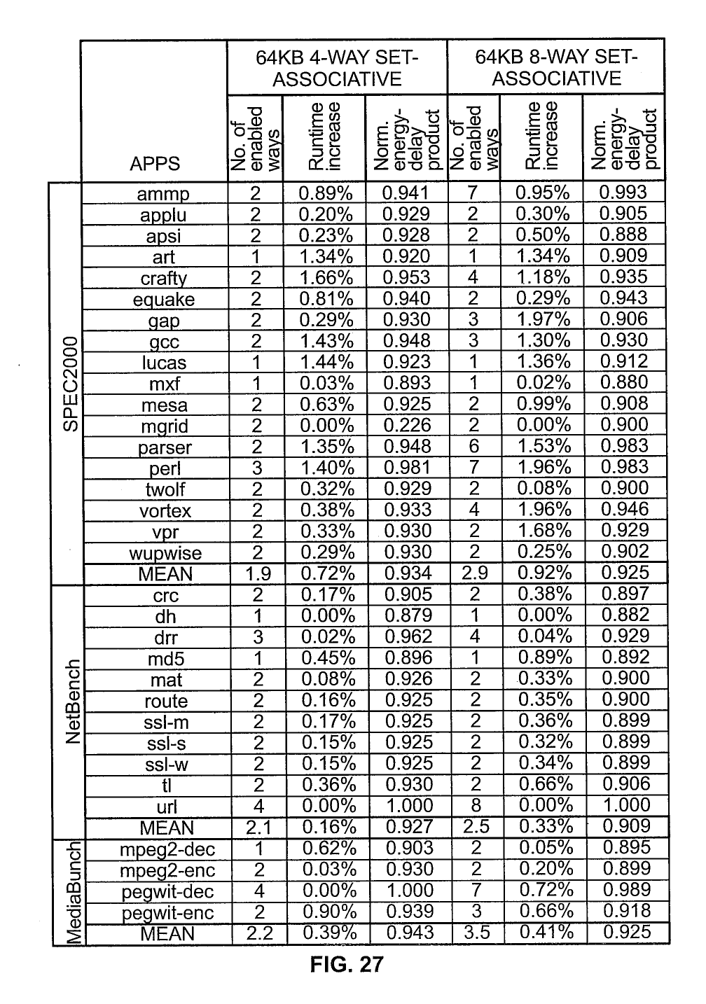

FIG. 24 depicts a method 800 for reducing power consumption using a block permutation scheme in an on-chip cache in accordance with an embodiment of the present invention. As described above, at step 810, cache locations experiencing high activity are determined. For example, an application may be frequently executing certain portions of code stored in certain areas on the cache. Spatial locality, for example, suggests that blocks with consecutive addresses are likely to be accessed within a short time interval. At step 820, cache constraints are referenced. For example, constraints regarding memory block locations/addressability, size, etc., may be referenced.

At step 830, physical locations of the memory blocks are permuted to obtain a physical distance between memory blocks. Thus, an average distance between logically neighboring blocks is maximized given cache constraints.

At step 840, logical addresses for the memory blocks are correlated with the permuted physical locations in the memory blocks for use by an application.

In certain embodiments, a permutation is generated for memory block numbers between an initial memory block address (“init”) and init+cache block size−1 in an array of blocks in the cache memory bank, for example. In certain embodiments, a permutation input is shifted with a different offset for each cache way, such that memory blocks that are physically next to each other do not correspond to the same logical rows and are not accessed simultaneously.

One or more of the steps of the method 800 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Certain embodiments provide improvements to reduce the power consumption in on-chip caches. Improvements rely on intelligently minimizing the power density of the hot spots and use thermal effects to reduce the power. The first technique, Power density Minimized-Architecture (PMA), enhances power-down techniques with power density (hence temperature) consideration of the active parts in the cache. Existing power-down techniques can be sub-optimal when thermal effects are considered. Instead of turning off entire banks, PMA architecture spreads out the active parts by turning off alternating rows in a bank. This reduces the power density of the active parts in the cache, which then lowers the junction temperature. Due to the exponential relationship between the leakage power and temperature, the drop in the temperature results in a significant energy savings from the remaining active parts of the cache. As an example, a cache structure with selective cache ways and gated-Vdd (SGA) is modified into PMA. The design changes required are minor, and the performance is not affected. Simulation results show that PMA can reduce the total energy by 14% and 53% compared to SGA and conventional cache, respectively. The second method proposed, Block Permutated Scheme (BPS), aims to maximize the physical distance between the logically consecutive blocks of the cache. Since there is spatial locality in caches, this distribution results in an increase in the distance between hot spots, thereby reducing the peak temperature.

Particularly, the BPS lowers the peak temperature of a 4-way associative level 1 instruction cache by 7° C. and reduces its total energy consumption by 5.6% on average. As technology keeps scaling down in the future, our techniques are likely to become more useful due to the increasing significance of electrothermal coupling.

Many other applications of the present invention as well as modifications and variations are possible in light of the above teachings. While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for reducing power consumption in an on-chip cache using a thermal-aware cache power down technique, the on-chip cache operating in conjunction with a processor and including at least one memory bank, said method comprising:
turning on a first row in a memory bank in an on-chip cache; and
turning off a second row in the memory bank in the on-chip cache.

2. The method of claim 1, further comprising selecting a distribution of rows to be turned off and rows to be turned on in the memory bank based on at least one application being executed.

3. The method of claim 2, wherein said selecting step further comprises dynamically selecting a distribution of rows to be turned off and rows to be turned on in the memory bank based on at least one application being executed.

4. The method of claim 1, further comprising disabling a subset of ways in a set-associative on-chip cache during periods of modest cache activity based on an application being executed, wherein when a way is disabled, decoders, pre-charges and sense-amplifiers for the way are turned off.

5. The method of claim 1, further comprising utilizing a gated-Vdd high threshold transistor as a switch in a supply voltage or ground path of memory cells in the memory banks of the on-chip cache, the transistor being turned on when the section is being used and turned off for low power mode.

6. A thermally aware on-chip cache system, said system comprising:
a memory bank comprising a plurality of rows;
a decoder associated with said memory bank for turning rows in said memory bank on and off;
a plurality of enable lines connecting said decoder and said plurality of rows in said memory bank; and
a cache controller controlling decoder operation via said plurality of enable lines to selectively enable and disable rows in said memory bank, wherein said cache controller turns on a first row in said memory bank and turns off a second row in said memory bank to provide alternating rows reducing power density in said on-chip cache.

7. The system of claim 6, wherein said first row and said second row are adjacent rows such that alternating rows in said memory bank of said on-chip cache are turned off rather than the entire memory bank to reduce power density of active parts of said on-chip cache.

8. The system of claim 6, wherein said first row comprises a first group of rows representing a first subset of said memory bank and said second row comprises a second group of rows representing a second subset of said memory bank.

9. The system of claim 6, further comprising disabling a subset of ways in a set-associative on-chip cache during periods of modest cache activity based on an application being executed, wherein when a way is disabled, decoders, pre-charges and sense-amplifiers for the way are turned off.

10. The system of claim 6, wherein each of said plurality of rows in said memory bank further comprises a gated-Vdd high threshold transistor acting as a switch in a supply voltage or ground path of said plurality of cells, the transistor being turned on when the row is being used and turned off when the row is in low power mode.

11. A method for reducing power consumption in an on-chip cache including a plurality of memory blocks, said method comprising:
referencing cache constraints regarding memory block locations and size;
permuting physical locations of said memory blocks in said on-chip cache architecture to obtain a physical distance between memory blocks, wherein an average distance between logically neighboring blocks is maximized given cache constraints; and
correlating logical addresses for said memory blocks with said permuted physical locations in said memory blocks for use by an application.

12. The method of claim 11, wherein said permuting and correlating steps are applied between a plurality of blocks in a working set of cache memory blocks.

13. The method of claim 11, wherein said permuting step utilizes spatial locality in said cache to distribute logical addresses for use by an application among physical locations in said memory blocks of said cache to increase distance between areas of high activity in the cache.

14. The method of claim 13, wherein said permuting step further comprises generating a permutation for memory block numbers between an initial memory block address (“init”) and init+cache block size−1 in an array of blocks in said cache memory bank.

15. The method of claim 14, wherein a permutation input is shifted with a different offset for each cache way, such that memory blocks that are physically next to each other do not correspond to the same logical rows and are not accessed simultaneously.

16. A thermally aware on-chip cache system, said system comprising:
a plurality of memory blocks each comprising a plurality of rows;
at least one decoder associated with said plurality of memory blocks for addressing said plurality of rows in said plurality of memory blocks;
a plurality of enable lines connecting said at least one decoder and said plurality of rows in said plurality of memory blocks; and
a cache controller controlling decoder operation via said plurality of enable lines to selectively address rows in said plurality of memory blocks,
wherein said cache controller permutes physical locations of said memory blocks in said on-chip cache architecture to obtain a physical distance between memory blocks, wherein an average distance between logically neighboring blocks is maximized given cache constraints and correlates logical addresses for said plurality of memory blocks with said permuted physical locations in said plurality of memory blocks for use by an application.

17. The system of claim 16, wherein said on-chip cache system rearranges decoders to facilitate permutation and addressing without addition of specialized hardware to the on-chip cache.

18. The system of claim 16, wherein said cache controller generates a permutation for memory block numbers between an initial memory block address (“init”) and init+cache block size−1 in an array of memory blocks in said on-chip cache.

19. The system of claim 18, wherein a permutation input is shifted with a different offset for each cache way, such that memory blocks that are physically next to each other do not correspond to the same logical rows and are not accessed simultaneously.

20. The system of claim 16, wherein said cache controller controls said decoder operation via said plurality of enable lines to selectively enable and disable rows in said plurality memory banks, wherein said cache controller turns on a first row in at least one of said memory banks and turns off a second row in at least one of said memory banks to provide alternating rows reducing power density in said on-chip cache.
